(19) United States
(12) Patent Application Publication
(10) Pub. No.: US 2026/0178359 A1
(43) Pub. Date: Jun. 25, 2026

(54) GENERATING GUIDANCE DIGITAL CONTENT WITH ARTIFICIAL INTELLIGENCE

(71) Applicant: eBay Inc., San Jose, CA (US)

(72) Inventors: Dineshbabu Bhoopalan, Fremont, CA (US); Oriol Caudevilla Torras, Seattle, WA (US); Chin-Jui Chen, San Mateo, CA (US); Saravanakumar Ganesan, San Jose, CA (US); Divyank Sharma, Gilroy, CA (US); Srinivasan Varippyreddy, Fremont, CA (US)

(73) Assignee: eBay Inc., San Jose, CA (US)

(21) Appl. No.: 18/990,321

(22) Filed: Dec. 20, 2024

(51) Int. Cl. G06F 9/451; G06Q 30/0242

(52) U.S. Cl. CPC G06F 9/453; G06Q 30/0246

(57) ABSTRACT

In the implementation of techniques for generating guidance digital content with artificial intelligence, a system receives digital content and metadata corresponding to item listings for an item category. The system filters the digital content based on predefined quality metrics and metadata to identify a subset of reference digital content, where each reference digital content meets or exceeds a predefined quality threshold. Via one or more artificial intelligence models, the system classifies the subset of reference digital content into distinct perspectives, each distinct perspective representing a different view of items included in the item category. Based on this classification, via the one or more artificial intelligence models, the system generates guidance digital content for each distinct perspective. The system broadcasts the guidance digital content for display via a user interface in association with the item category.

### BACKGROUND

Conventional techniques for generating guidance digital content for item listings on online platforms are often limited in scope and adaptability. These conventional techniques typically rely on static content manually created by human designers. This static approach makes it challenging to provide dynamic and comprehensive guidance for the vast and continually expanding range of item listings made available on the online platforms. As a result, users often lack the tools needed to create detailed, high-quality item listings, leading to suboptimal item representation and reduced user engagement.

Furthermore, these conventional techniques require significant manual intervention, which substantially limit scalability. The reliance on static, manually crafted guidance digital content prevents timely updates to guidance materials that align with evolving item categories, item presentation styles, and trends in user behavior. Consequently, service provider systems are unable to deliver relevant and adaptive guidance digital content dynamically, not only limiting scalability but increasing computational overhead to manage, update, and distribute the static digital content.

### SUMMARY

Techniques and systems for generating guidance digital content with artificial intelligence are described. In an example, a computing device receives a plurality of digital content and metadata corresponding to item listings for an item category. The computing device filters the plurality of digital content based on predefined quality metrics and the metadata to identify a subset of reference digital content for the item category, wherein each reference digital content exceeds a predefined quality threshold.

With an artificial intelligence model, the computing device classifies the subset of reference digital content into distinct perspectives, wherein each distinct perspective corresponds to a different perspective of items included in the item category. Based on the subset of reference digital content, the computing device generates guidance digital content for each of the distinct perspectives with the artificial intelligence model. Upon generation of the guidance digital content, the computing device broadcasts the guidance digital content for display via a user interface in association with the item category.

The disclosed techniques and systems efficiently generate guidance digital content with artificial intelligence without unnecessary constraints on the scalability of the guidance digital content operations.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for generating guidance digital content with artificial intelligence as described herein.

FIG. 2 depicts a system in an example implementation showing operation of the guidance management system for generating the guidance digital content.

FIG. 3 depicts a system in an example implementation showing operation of the guidance management system for training an artificial intelligence model.

FIG. 4 depicts a system in an example implementation showing operation of the guidance management system for generating guidance digital content based on a predefined condition.

FIG. 5 depicts an example implementation of a user interface configured to receive digital content for an item listing of an item category.

FIG. 6 depicts an example implementation of a user interface configured to display guidance digital content generated with artificial intelligence for an item listing of an item category.

FIG. 7 depicts a procedure in an example implementation of generating guidance digital content with artificial intelligence.

FIG. 8 illustrates an example system including various components of an example device that can be implemented as any type of computing device as described and/or utilized with reference to FIGS. 1-7 to implement examples of the techniques described herein.

### DETAILED DESCRIPTION

### Overview

Conventional techniques for generating guidance digital content result in inefficiencies, such as significant manual intervention, which lead to suboptimal scalability constraints. These conventional techniques, which are characterized by static guidance digital content, fail to adapt to the fluctuating needs inherent in guidance digital content operations.

Techniques for generating guidance digital content with artificial intelligence are described that overcome these limitations. For instance, consider an example in which a service provider system detects the emergence of a new item category—such as a recently introduced category of wearable devices. In response, the service provider system initiates an automated process to generate guidance digital content tailored to the new category of wearable devices.

The service provider system receives images and associated metadata corresponding to the item category (e.g., item descriptions, user-provided tags, and so forth), for instance, from item listings with metrics exceeding a predefined quality threshold. The service provider system filters these images based on predefined quality metrics, such as resolution or alignment, to identify a subset of reference images that meet or exceed a predefined quality threshold.

The service provider system processes the subset of reference images via one or more artificial intelligence models, classifying the reference images into distinct perspectives such as front view, side view, or a detailed close-up of the wearable device. Using this classification, the service provider system generates guidance images providing guidance on digital content capture techniques for capturing each distinct perspective. The service provider system broadcasts these guidance images to a client device for display via a user interface, enabling users to leverage the dynamically generated guidance images for the new item category.

By automating the generation of guidance digital content, the described techniques address the limitations of conventional methods by eliminating the need for manual intervention, ensuring that the guidance digital content remains relevant and responsive to dynamic or real-time changes, and reducing latency in adapting to new item categories. This dynamic approach scales efficiently, enhances the quality and consistency of item listings, improves user engagement, and resolves latency issues inherent in conventional techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

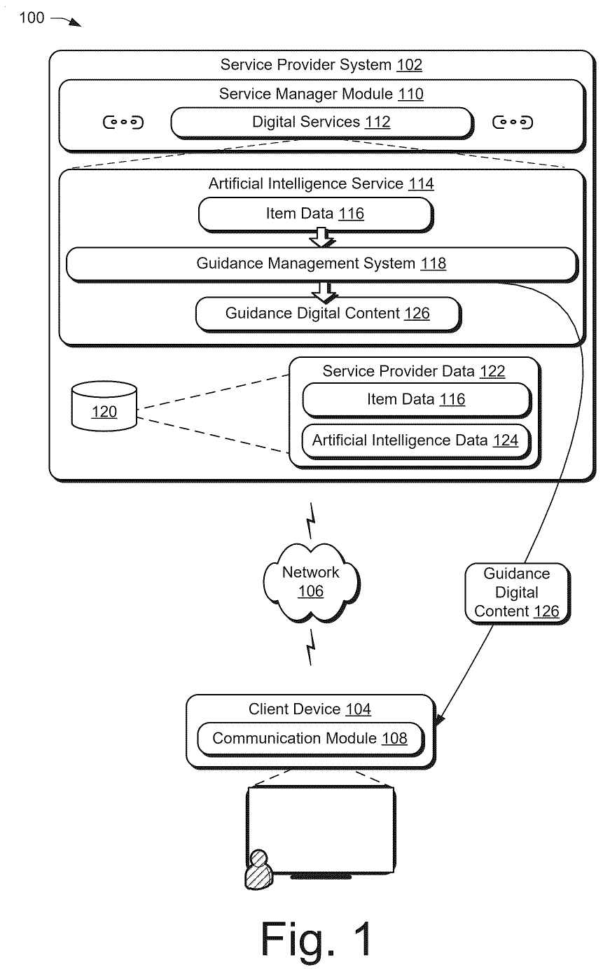

FIG. 1 is an illustration of a digital medium environment 100 in an example implementation that is operable to employ techniques and systems for generating guidance digital content with artificial intelligence

The illustrated environment 100 includes a service provider system 102 and a client device 104 that are communicatively coupled, one to another, via a network 106. Computing devices that implement the service provider system 102 and the client device 104 are configurable in a variety of ways.

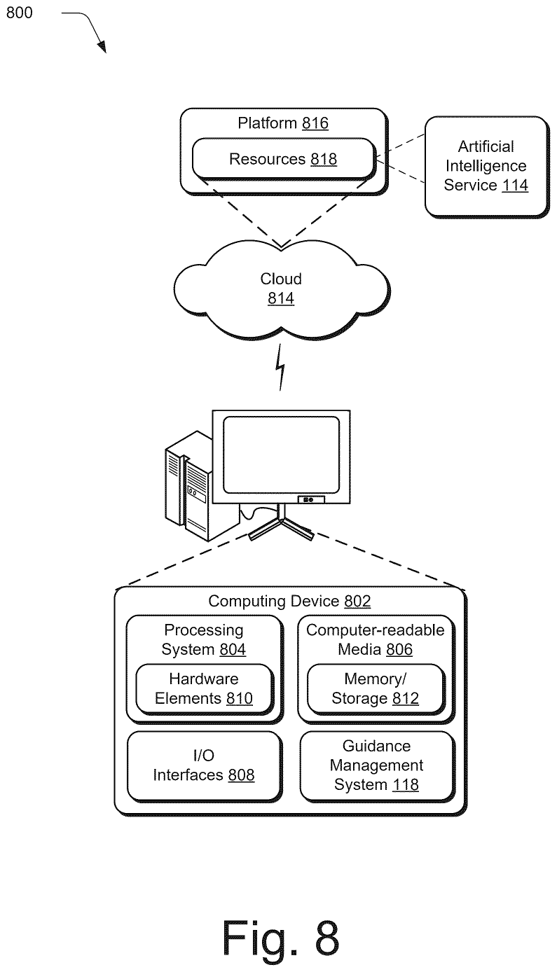

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is described in some examples, a computing device is representative of a plurality of different devices, such as multiple servers utilized by a business to perform operations “over the cloud” as described in FIG. 8.

The client device 104 includes a communication module 108 that is representative of functionality to communicate via the network 106 with a service manager module 110 of the service provider system 102. The service manager module 110 is configured to implement digital services 112. Examples of the digital services 112 include cloud storage, data analytics, APIs for integrating external applications, and item listing services. The digital services 112 are usable to expose a variety of functionality to the client device 104, an example of which is illustrated as an artificial intelligence service 114.

The artificial intelligence service 114 is configured to manage artificial intelligence content based on received inputs. The artificial intelligence service 114, for instance, can generate, train, and deploy artificial intelligence models, communicate with them, and generate guidance digital content. In the illustrated example, the artificial intelligence service 114 employs item data 116. The item data 116 includes data pertaining to item listings for the service provider system 102. Examples of the item data 116 include data such as item descriptions, item listings, digital content (e.g., images, videos, audio, etc.), reviews, inventory levels, digital content quality metrics (e.g., image resolution), conversion rates or conversion counts, click-through rates, views, prices, and metadata (e.g., tags, item categories, user ratings, digital content aspect ratio, etc.) associated with item listings.

The artificial intelligence service 114 includes a guidance management system 118 that is configured for managing deployment of guidance digital content 126 and artificial intelligence resources available for the guidance digital content. The guidance management system 118, in some instances, generates the guidance digital content 126 based on the item data 116. Examples of the generating of the guidance digital content 126 include generating guidance images, guidance descriptions, guidance videos, guidance augmented reality, guidance audio, and so forth.

The guidance management system 118, in some instances, generates artificial intelligence data 124, such as one or more artificial intelligence models. Examples of the generating of the artificial intelligence data 124 include generating training data for the one or more artificial intelligence models, training the one or more artificial intelligence models, configuring a pre-trained artificial intelligence model for the one or more artificial intelligence models, and selecting a pre-existing artificial intelligence model for the one or more artificial intelligence models.

The guidance management system 118 uses service provider data 122 stored in storage device 120 to manage, generate, and deploy the guidance digital content 126. The service provider data 122 includes data pertaining to the offerings (e.g., the digital services 112) and operations of the service provider system 102. The service provider data 122 includes the item data 116 pertaining to item listings, item categories, and items made available via the service provider system 102. In some examples, the service provider data 122 includes the artificial intelligence data 124 pertaining to artificial intelligence operations of the service provider system 102 (e.g., of the guidance management system 118), such as training data, reference guidance digital content, prompt data, computing resource data, or one or more artificial intelligence models.

The guidance management system 118, in some instances, broadcasts the guidance digital content 126 to the communication module 108 of the client device 104 for display via the user interface of the client device 104. The components of the service provider system 102 and the computing device 104 create a robust framework for deploying and managing the artificial intelligence services 114 and the guidance digital content 126.

These components enable scalable, dynamic generation of guidance digital content with artificial intelligence and ensure the guidance management system 118 adapts effectively to evolving real-time conditions for item categories. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Generating Guidance Digitial Content With Artificial Intelligence

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks.

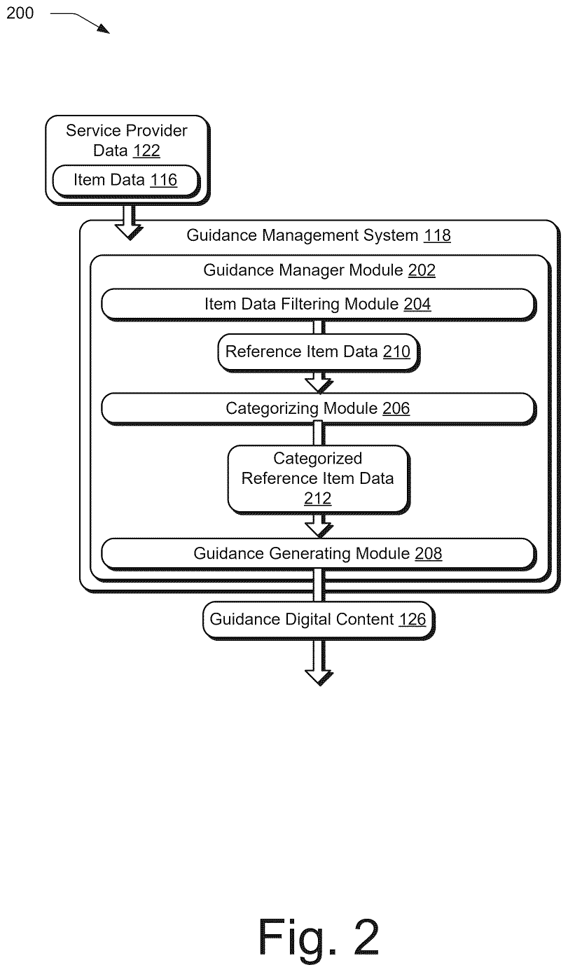

FIG. 2 depicts a system 200 in an example implementation showing operation of the guidance management system 118 of FIG. 1 in greater detail as generating the guidance digital content 126 with artificial intelligence. The guidance management system 118 implemented in this example includes a guidance manager module 202 including an item data filtering module 204, a categorizing module 206, and a guidance generating module 208.

The guidance manager module 202 of the guidance management system 118 is illustrated as receiving the service provider data 122, in which the service provider data 122 includes the item data 116 of FIG. 1. The item data 116 is configurable in a variety of ways, examples of which include digital images and metadata corresponding to item listings of an item category of the service provider system 102. Examples of the metadata include but are not limited to digital content quality (e.g., image quality), resolution, aspect ratio, item listing performance metrics, and so forth.

The guidance manager module 202 is configured to manage operations for guidance corresponding to item listings and item categories. The guidance manager module 202 is configurable in various ways, examples of which include receiving service provider data 122, managing various stages of data filtering, data classification, and guidance digital content generation, and so forth.

To continue this illustrated example system 200, the guidance manager module 202 communicates the service provider data 122 including the item data 116 to the item data filtering module 204. The item data filtering module 204 is configured to filter the service provider data 122 (e.g., the item data 116) such that high-quality data is output for processing by the guidance manager module 202. In some examples, the item data filtering module 204 evaluates quality metrics of the service provider data 122 against predefined quality metric thresholds. Examples of the metrics include but are not limited to digital content resolution, clarity, relevance to the item category. In some embodiments, the item data filtering module 204 is configured to filter the service provider data 122 by identifying a subset of the service provider data 122 including the metrics meeting or exceeding a predefined quality threshold.

In some examples, the item data filtering module 204 filters for high-quality item listings (including the digital content and metadata associated with the high-quality item listings) of the service provider data 122 from the item listings received based on predefined quality metrics and the performance metrics corresponding to the item listings received. Examples of the performance metrics include conversion rates, click-through rates, add-to-cart rates, add-to-wish list rates, review scores, user engagement metrics, and so forth. For example, if a predefined quality threshold for conversion rates is at least 5%, the item data filtering module 204 filters the subset of item listings including a conversion rate of 5% or above. The performance metrics and the predefined quality threshold are expressible in various ways, such as a normalized score, a ranking, a severity, a probability, a percentage, a fraction, semantically, numerically, or so forth.

In some embodiments, the item data filtering module 204 filters the digital content of the service provider data 122 by assigning a score to each digital content based on quality assessment metrics. The score is expressible in various ways, such as a normalized score, a ranking, a severity, a probability, a percentage, a fraction, semantically, numerically, or so forth. Examples of the quality assessment metrics include digital content resolution, clarity, relevance, aspect ratio, and viewing duration. For instance, in some examples, the digital content that meets a predefined resolution threshold of at least 1920×1080 pixels is filtered for by the item data filtering module 204.

In some examples, the item data filtering module 204 filters the service provider data 122 by assigning a score for each item listing by weighing one or more of the quality metrics (e.g., conversion rate, review score, and so forth) into a ranking score. By way of example, item listings above a predefined threshold ranking score are filtered for by the item data filtering module 204 as high-quality item listings (e.g., top-performing listings), or reference item listings including reference item data 210. The item data filtering module 204 is configured to filter out the item listings (and the digital content associated the respective item listings) such that they are excluded from further processing by the guidance manager module 202. In this way, only the most relevant, sufficiently performing, and visually suitable item listings are leveraged by the guidance manager module 202 to contribute to the generation of effective guidance digital content 126.

Based on the filtering of the service provider data 122, the item data filtering module 204 outputs the reference item data 210, wherein the reference item data 210 represents a high-quality subset of the service provider data 122 or the item data 116. In some examples, the item data filtering module 204 performs the filtering operations via one or more artificial intelligence models.

To continue this illustrated example system 200, the item data filtering module 204 passes the reference item data 210 to the categorizing module 206. The categorizing module 206 is configured to categorize the reference item data 210 into distinct categories, such as distinct perspectives. The distinct perspectives refer to a distinct view or angle of the item of the item category, such as a front view, a side view, a top view, an inside view, and bottom view, a macro view, a 360° rotation view, a scale comparison view, a three-dimensional view, a cutaway view, an animated view, a dimensional view, an in-use view, or so forth.

In some examples, the categorizing module 206 leverages one or more artificial intelligence models configured for categorizing the reference item data 210 by processing the attributes of the reference item data 210. In some examples, the one or more artificial intelligence models are configured to distinguish between different perspectives or angles of the items represented in the reference item data 210. In some embodiments, the one or more artificial intelligence models are configured to identify new distinct perspectives from the items represented by the reference item data 210.

In some embodiments, the one or more artificial intelligence models include one or more of convolutional neural networks, diffusion models, vision transformers, natural language processing models, or machine learning models. In general, a diffusion model is a probabilistic generative artificial intelligence model that learns to reverse a noise-adding process (diffusion) to generate data or reconstruct data distributions. Diffusion models include a forward process that gradually adds noise to data and a reverse process that denoises the data step-by-step, recovering the original or generating new samples. Examples of diffusion models include Denoising Diffusion Probabilistic Models (DDPMs), Latent Diffusion Models (LDMs, such as Stable Diffusion), and Score-Based Generative Models.

The one or more artificial intelligence models are configured to use various techniques for categorizing the reference item data 210 into the categorized reference item data 212, examples of which include feature extraction, classification algorithms for the distinct perspectives, hierarchical organization of the reference item data 210 for each of the distinct perspectives, validation mechanisms and error correction (e.g., via confidence scores generated by the one or more artificial intelligence models), metadata enrichment (e.g., tagging), or so forth. By leveraging categorization with artificial intelligence to output the categorized reference item data 212, the categorizing module 206 ensures that each of the distinct perspectives is accurately represented, enabling generation of the guidance digital content 126 tailored to the distinct views.

To continue this illustrated example system 200, the categorizing module 206 communicates the categorized reference item data 212 to the guidance generating module 208. The guidance generating module 208 is configured to generate the guidance digital content 126 via the one or more artificial intelligence models, based on the categorized reference item data 212. In some embodiments, the guidance digital content 126 includes digital content representing each of the distinct perspectives of the categorized reference item data 212. Examples of the guidance digital content 126 include digital images, videos, audio, text, augmented reality (e.g., an augmented reality overlay for aligning a physical object with a distinct perspective), and virtual reality content. In some examples, the guidance digital content 126 includes contour images (e.g., stencil images, contour representations, etc.) representing each of the distinct perspectives, in which the contour images are outlines (e.g., black outlines) of the item. In some examples the guidance digital content 126 is stylistically uniform.

In some examples, the guidance generating module 208 validates the guidance digital content 126 by comparing it against predefined quality metrics, such as clarity and proportionality. The guidance generating module 208 is configured, in some instances, to store the guidance digital content 126 with metadata such as the item category, the distinct perspective, the date of generation, and so forth.

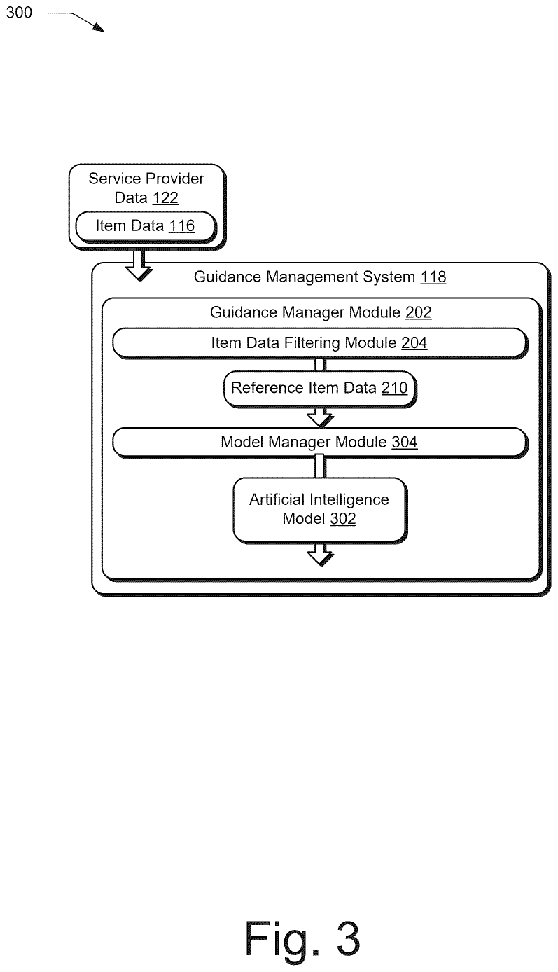

The guidance generating module 208 communicates (e.g., broadcasts) the guidance digital content 126 generated. In some embodiments, the guidance generating module 208 broadcasts the guidance digital content 126 to the communication module 108 of the client device 104 for display via the user interface. In some examples, the guidance generating module 208 stores the guidance digital content 126 with contextual information. Examples of the contextual information include the item category type, item dimensions, recommended capture configurations, and so forth. In the context of the guidance management system 118, consider the following discussion of FIG. 3.

FIG. 3 depicts a system 300 in an example implementation showing operation of the guidance management system 118 of FIGS. 1 and 2 for training an artificial intelligence model for generating the guidance digital content 126. As already noted, the illustrated system 300 includes the guidance management system 118 of FIG. 1, which incorporates the guidance manager module 202 and the item data filtering module 204 of FIG. 2.

To begin this example of the system 300, the guidance manager module 202 receives the service provider data 122 including the item data 116. In some examples, the service provider data 122 includes historical data pertaining to item categories and item listings corresponding to the item categories. The guidance manager module 202 communicates the service provider data 122 to the item data filtering module 204.

As already discussed throughout, the item data filtering module 204 is configured to filter the service provider data 122 (e.g., the item data 116) to produce high-quality data, referred to as the reference item data 210, for processing. In some embodiments, the reference item data 210 is usable as training data for artificial intelligence models. The item data filtering module 204 processes the service provider data 122 to output the reference item data 210. The item data filtering module 204 communicates the reference item data 210 to the model manager module 304.

To continue this example of the system 300, the model manager module 304 receives the reference item data 210 for training one or more artificial intelligence models for generating the guidance digital content 126. The model manager module 304 is configured to manage artificial intelligence models associated with the guidance digital content 126. The model manager module 304 is configurable in various ways, such as to generate the artificial intelligence model 302, to train the artificial intelligence model 302, deploy the artificial intelligence model 302, and so forth. Based on at least the reference item data 210, the model manager module 304 trains the artificial intelligence model 302.

The model manager module 304 is configured to use techniques such as preprocessing of the reference item data 210 to prepare the reference item data 210 for training, examples of which include data augmentation, normalization, and labeling. Examples of data augmentation include generating variations of the reference item data 210 to improve model generalization. Examples of normalization include standardizing pixel values of the reference item data 210 and metadata formats for consistency. Examples of labeling include organizing the reference item data 210 into distinct categories or perspectives, such as front views, side views, and so forth.

In some examples, the model manager module 304 integrates multi-task learning in the training of the artificial intelligence model 302, enabling the artificial intelligence model 302 to share learned features across a plurality of tasks, therefore improving overall efficiency and accuracy.

In some embodiments, the model manager module 304 employs validation techniques during training to ensure that the artificial intelligence model 302 does not overfit to the reference item data 210. In some examples, the model manager module 304 outputs the artificial intelligence model 302, in which the artificial intelligence model 302 is configured to perform at least one of categorizing the item data 116 into the distinct perspectives or generating the guidance digital content 126.

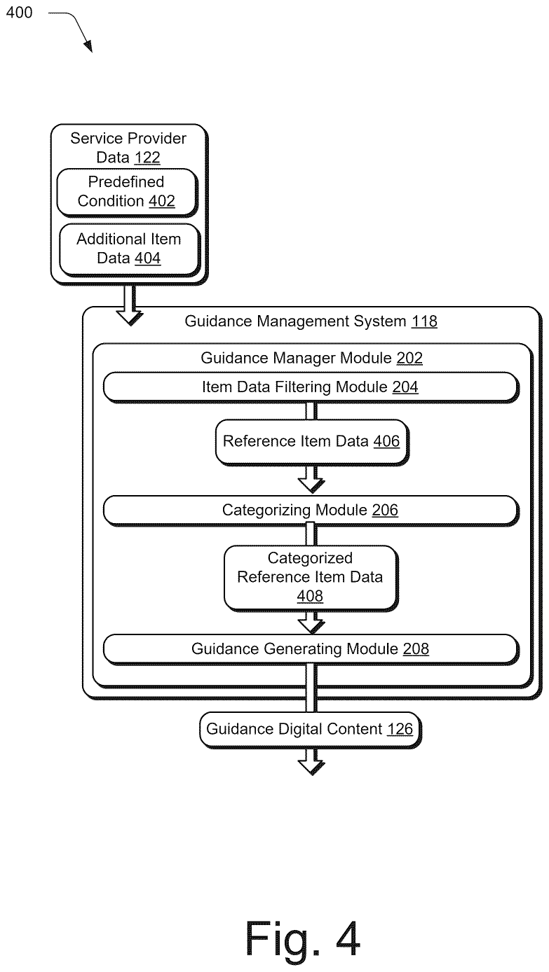

The model manager module 304 is configurable to perform other tasks pertaining to artificial intelligence, examples of which include evaluation of the artificial intelligence model 302, deployment preparation, and feedback loop integration. In the context of the guidance management system 118, consider the following discussion of FIG. 4.

FIG. 4 depicts a system 400 in an example implementation showing operation of the guidance management system 118 of FIGS. 1, 2, and 3, for generating the guidance digital content 126 based on a predefined condition 402. As already noted, the illustrated system 400 includes the guidance management system 118 of FIG. 1, in which the guidance management system 118 includes the guidance manager module 202 including the item data filtering module 204, the categorizing module 206, and the guidance generating module 208 of FIG. 2.

To begin this example of the system 400, the guidance manager module 202 of the guidance management system 118 receives the service provider data 122 including a predefined condition 402 and additional item data 404. The predefined condition 402 represents a condition that triggers the guidance management system 118 to generate the guidance digital content 126 for a specific item category.

Various examples of the predefined condition 402 exist, including missing guidance digital content for an item category, a request for guidance digital content for an item category, an item category having performance metrics below a predefined threshold amount, new item categories, seasonal trends, emerging user preferences, incomplete item listings, item listings having performance metrics below a predefined threshold amount, the additional item data 404, an item category including guidance images below a predefined threshold number of guidance images, and so forth. The predefined threshold amount and the performance metrics are expressible in various ways, such as a normalized score, a ranking, a severity, a probability, a percentage, a fraction, semantically, numerically, or so forth. In some examples, the predefined condition 402 is an item category of a plurality of item categories that does not exceed a predefined threshold number of the guidance digital content 126.

The additional item data 404 includes additional data pertaining to item listings for the service provider system 102, such as new data pertaining to item listings for the service provider system 102. The guidance manager module 202 communicates the service provider data 122 including the predefined condition 402 and the additional item data 404 to the item data filtering module 204.

As discussed throughout, the item data filtering module 204 is configured to filter the service provider data 122 (e.g., the item data 116) such that high-quality data is output for processing. Based on the service predefined condition, the item data filtering module 204 processes the service provider data 122 including the additional item data 404 to generate the reference item data 406. The item data filtering module 204 communicates the reference item data 406 to the categorizing module 206.

To continue this illustrated example system 400, the categorizing module 206 receives the reference item data 406. As discussed throughout, the categorizing module 206 is configured to categorize the reference item data 210 into distinct categories, such as distinct perspectives. The distinct perspectives refers to a distinct view or angle of the item of the item category, such as a front view, a side view, a top view, an inside view, and bottom view, a macro view, a 360° rotation view, a scale comparison view, a three-dimensional view, a cutaway view, an animated view, a dimensional view, an in-use view, or so forth. The categorizing module 206 processes the reference item data 406 to generate the categorized reference item data 408.

In some examples, the categorizing module 206 leverages one or more artificial intelligence models configured for categorizing the reference item data 406 by processing the attributes of the reference item data 406. In some examples, the one or more artificial intelligence models are configured to distinguish between different perspectives or angles of the items represented in the reference item data 406. In some embodiments, the one or more artificial intelligence models are configured to identify new distinct perspectives from the items represented by the reference item data 406.

In some embodiments, the one or more artificial intelligence models include one or more of convolutional neural networks, vision transformers, natural language processing models, or machine learning models. The one or more artificial intelligence models are configured to use various techniques for categorizing the reference item data 406 into the categorized reference item data 408, examples of which include feature extraction, classification algorithms for the distinct perspectives, hierarchical organization of the reference item data 406 for each of the distinct perspectives, validation mechanisms and error correction (e.g., via confidence scores generated by the one or more artificial intelligence models), metadata enrichment (e.g., tagging), or so forth.

By leveraging categorization with artificial intelligence to output the categorized reference item data 408, the categorizing module 206 ensures that each of the distinct perspectives is accurately represented, enabling generation of the guidance digital content 126 tailored to the distinct views.

To continue this illustrated example system 400, the categorizing module 206 communicates the categorized reference item data 408 to the guidance generating module 208. As discussed throughout, the guidance generating module 208 is configured to generate the guidance digital content 126 via the one or more artificial intelligence models, based on the categorized reference item data 408. Via the one or more artificial intelligence models (e.g., the artificial intelligence model 302), the guidance generating module generates the guidance digital content 126 for display via the user interface of the client device 104.

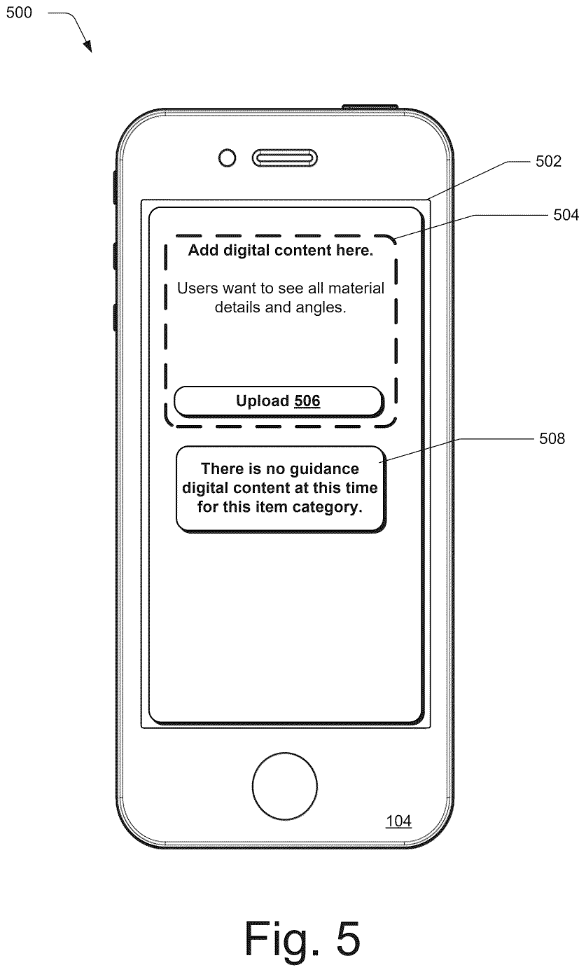

In some examples, the guidance generating module 208 is configured to filter the guidance digital content 126 (e.g., guidance images) generated based on predefined guidance digital content quality metrics, such as predefined guidance image quality metrics. Examples of the predefined guidance image quality metrics include a resolution of the image, a size of the image, and so forth. In the context of the guidance management system 118, consider the following discussion of FIG. 5.

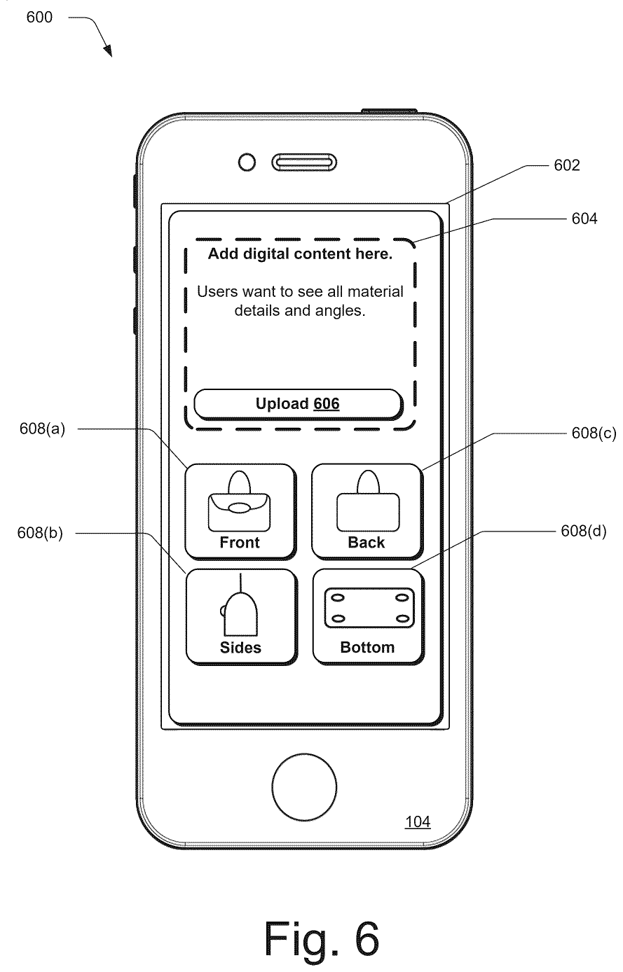

FIG. 5 depicts an example implementation 500 of a user interface 502 configured to receive digital content for an item listing of an item category. The user interface 502, as illustrated for the computing device 104, includes a module 504 for adding digital content to the item listing of the item category. The user interface 502 includes a selectable user element 506 for uploading the digital content representative of the item for the item listing and a user element 508 indicating that “There is no guidance digital content at this time for this item category”. In the context of the module 504 for adding the digital content to the item listing of the item category, consider the following discussion of FIG. 6.

FIG. 6 depicts an example implementation 600 of a user interface 602 configured to display the guidance digital content 608(a)-(d) generated with artificial intelligence for the item listing of the item category of FIG. 5. The user interface 602, as illustrated for the computing device 104, includes a module 604 for adding digital content to the item listing of the item category. The user interface 602 includes a selectable user element 606 for uploading the digital content representative of the item for the item listing and the guidance digital content 608(a)-(d) generated with artificial intelligence (e.g., the artificial intelligence model 302) for the item listing for the item category of FIG. 5.

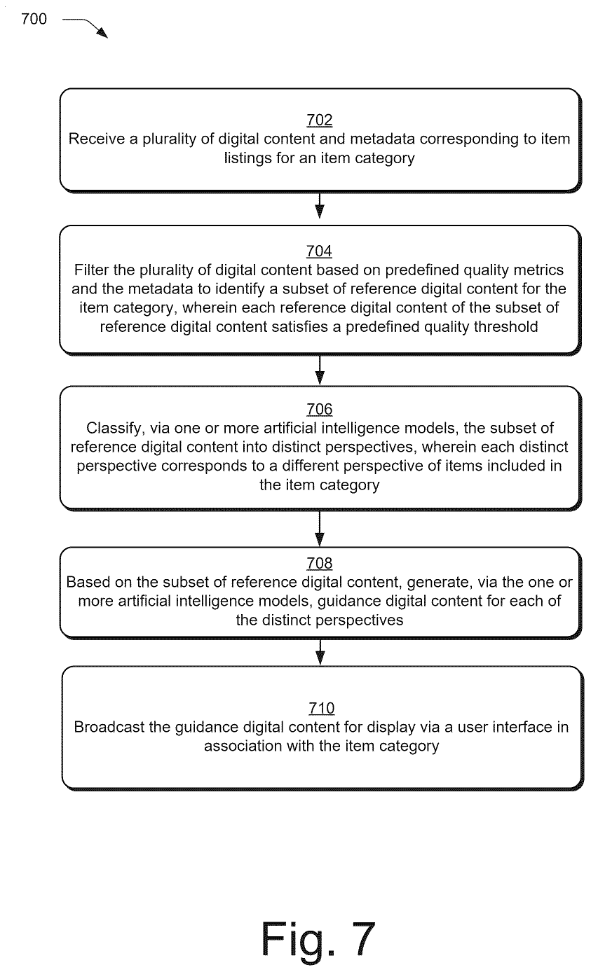

In some implementations, the guidance digital content are stencils. In this example implementation 600, the guidance digital content 608(a)-(d) represent distinct perspectives of the item, in which the guidance digital content 608(a)-(d) are contours or outlines (e.g., black outlines) of the item. Although the item is depicted as a purse in this example implementation, other implementations may include difference perspectives (e.g., different stencil perspectives) of different items, such as different perspectives for a shoe or an artificial intelligence plushie. In the context of generating the guidance digital content 126 with artificial intelligence (e.g., the artificial intelligence model 302), consider next the following discussion of FIG. 7.

### Example Procedures

The following discussion describes techniques that are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-7.

FIG. 7 depicts a procedure 700 in an example implementation of generating the guidance digital content 126 with artificial intelligence. At block 702, a plurality of digital content and metadata corresponding to item listings for an item category is received. In some examples, the guidance management system 118 receives the service provider data 122 including the item data 116. In some embodiments, the item data 116 includes digital content and metadata corresponding to the item listings for the item category. As discussed throughout, examples of the item data 116 include item descriptions, item listings, digital content (e.g., images, videos, audio), and metadata (e.g., tags, categories, ratings, aspect ratios) associated with the item category.

At block 704, the plurality of digital content is filtered based on predefined quality metrics and the metadata to identify a subset of reference digital content for the item category, wherein each reference digital content of the subset of reference digital content satisfies a predefined quality threshold. As discussed throughout, the reference item data 210 includes the reference digital content. In some embodiments, the item data filtering module 204 filters the service provider data 122 including the item data 116 including the plurality of digital content and the metadata for the reference item data 210.

At block 706, the subset of reference digital content is classified into distinct perspectives via one or more artificial intelligence models, wherein each distinct perspective corresponds to a different perspective of items included in the item category. In some examples, the categorizing module 206 processes the reference item data 210 and classifies the reference item data 210 to output the categorized reference item data 212. In some embodiments, the categorizing module 206 leverages the artificial intelligence model 302 to perform the classification of the reference item data 210 into the distinct perspectives.

At block 708, based on the subset of reference digital content and via one or more artificial intelligence models, guidance digital content 126 for each of the distinct perspectives is generated. In some embodiments, the guidance generating module 208 generates the guidance digital content 126 via one or more artificial intelligence models, such as the artificial intelligence model 302. As discussed throughout, the distinct perspectives represent a distinct view or angle of the item of the item category, such as a front view, a side view, a top view, an inside view, and bottom view, a macro view, a 360° rotation view, a scale comparison view, a three-dimensional view, a cutaway view, an animated view, a dimensional view, an in-use view, or so forth.

At block 710, the guidance digital content 126 is broadcasted for display via a user interface in association with the item category. In some examples, the guidance generating module 208 broadcasts the guidance digital content 126 (e.g., the guidance digital content 608(a)-(d)) for display via the user interface (e.g., the user interface 602) of the client device 104. As discussed throughout, the guidance digital content 126 is displayable in various ways, examples of which include in association with the item category, in association with the item listing, and so forth.

In the context of an example system and device for generating guidance digital content with artificial intelligence, consider next the following discussion of FIG. 8.

### Example System and Device

FIG. 8 illustrates an example system generally at 800 that includes an example computing device 802 that is representative of one or more computing systems and/or devices that implement the various techniques described herein. This is illustrated through inclusion of the guidance management system 118 and the artificial intelligence service 114. The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices and/or processing systems 804) to implement techniques, modules, and examples described herein.

The techniques described herein are supported by various configurations of the computing device 802 and are not limited to the specific examples of the techniques described herein. This functionality is also implementable through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device example, implementation of functionality described herein is distributable throughout the system 800. For example, the functionality is implementable in part on the computing device 802 as well as via the platform 816 that abstracts the functionality of the cloud 814.

What is claimed is:

1. A computer-implemented method comprising:
receiving a plurality of images and metadata corresponding to item listings for an item category;
filtering the plurality of images based on predefined quality metrics and the metadata to identify a subset of reference images, wherein each reference image of the subset of reference images exceeds a predefined quality threshold;
classifying, via one or more artificial intelligence models, the subset of reference images into distinct perspectives, wherein each distinct perspective corresponds to a different perspective of items included in the item category;
generating, based on the subset of reference images and via the one or more artificial intelligence models, guidance images for each of the distinct perspectives; and
broadcasting the guidance images for display via a user interface in association with the item category.

2. The computer-implemented method of claim 1, wherein the guidance images are stencil images, wherein the stencil images are contour representations of items associated with the item category.

3. The computer-implemented method of claim 1, further comprising filtering the guidance images generated based on predefined guidance image quality metrics.

4. The computer-implemented method of claim 1, wherein the predefined quality metrics include one or more of click-through rates or conversion counts associated with each respective item listing associated with the plurality of images.

5. The computer-implemented method of claim 1, wherein an artificial intelligence model of the one or more artificial intelligence models is a diffusion model.

6. The computer-implemented method of claim 1, wherein the distinct perspectives include one or more of front view, side view, top view, inside view, or bottom view.

7. The computer-implemented method of claim 1, wherein the metadata includes one or more of item attributes, user ratings, image resolution, or image aspect ratio.

8. The computer-implemented method of claim 1, further comprising:
detecting an item category of a plurality of item categories that does not exceed a predefined threshold number of guidance images; and
triggering generation of one or more guidance images for the item category detected.

9. The computer-implemented method of claim 1, further comprising storing the guidance images with contextual information including one or more of category type, item dimensions, or recommended capture configurations.

10. The computer-implemented method of claim 1, wherein the one or more artificial intelligence models are trained by using historical image data for a plurality of item listings exceeding a predefined threshold quality based on predefined performance metrics.

11. The computer-implemented method of claim 1, wherein an artificial intelligence model of the one or more artificial intelligence models is a machine learning model.

12. A non-transitory computer-readable storage medium storing executable instructions, which when executed by a processing device, cause the processing device to perform operations comprising:
receiving a plurality of digital content and metadata corresponding to item listings for item categories;
based on the plurality of digital content and metadata, training one or more artificial intelligence models for generating guidance digital content corresponding to one or more additional item categories;
detecting a predefined condition corresponding to triggering generation of the guidance digital content corresponding to the one or more additional item categories;
responsive to the detecting, generating, at least in part via the one or more artificial intelligence models, the guidance digital content corresponding to the one or more additional item categories, wherein the generating comprises:
receiving a plurality of additional digital content and metadata corresponding to item listings for an additional item category;
filtering the plurality of additional digital content and metadata corresponding to item listings for the additional item category to identify a subset of reference digital content for the additional item category, wherein each reference digital content satisfies a predefined quality threshold;
classifying the subset of reference digital content into distinct views, wherein each distinct view corresponds to a different perspective of items included in the additional item category; and
based on the subset of reference digital content, generating the guidance digital content corresponding to the one or more additional item categories; and
broadcasting the guidance digital content for display via a user interface in association with the item category.

13. The non-transitory computer-readable storage medium of claim 12, wherein the guidance digital content includes guidance images.

14. The non-transitory computer-readable storage medium of claim 12, wherein the guidance digital content includes an augmented reality overlay for aligning a physical object with a distinct perspective while capturing digital content.

15. The non-transitory computer-readable storage medium of claim 12, wherein the predefined condition is one of an item category without existing guidance digital content, a request for new guidance digital content, or an item category including performance metrics below a predefined threshold amount.

16. A system comprising:
a memory component; and
a processing device coupled to the memory component, the processing device to perform operations comprising:
receiving a plurality of images and metadata corresponding to item listings for an item category;
filtering the plurality of images based on predefined quality metrics and the metadata to identify a subset of reference images, wherein each reference image of the subset of reference images exceeds a predefined quality threshold;
classifying, via one or more artificial intelligence models, the subset of reference images into distinct perspectives, wherein each distinct perspective corresponds to a different perspective of items included in the item category;
generating, based on the subset of reference images and via the one or more artificial intelligence models, guidance images for each of the distinct perspectives; and
broadcasting the guidance images for display via a user interface in association with the item category.

17. The system of claim 16, further comprising:
receiving a plurality of item listings corresponding to the item category;
filtering the plurality of item listings to identify a subset of top-performing listings based on predefined performance metrics; and
extracting, for each top-performing listing, associated item images and metadata, and wherein the plurality of images and metadata corresponding to the item listings for the item category are the associated item images and metadata.

18. The system of claim 16, wherein the metadata includes one or more of image perspectives, resolutions, or aspect ratios.

19. The system of claim 16, wherein the one or more artificial intelligence models include one or more of convolutional neural networks, vision transformers, or natural language processing models.

20. The system of claim 16, further comprising:
detecting that one or more performance metrics of the item category are below a predefined threshold amount; and
based on the detecting, initiating generating of the guidance images.
